(19) United States
(12) Patent Application Publication
(10) Pub. No.: US 2012/0044701 A1
(43) Pub. Date: Feb. 23, 2012

(54) Lamp Seat Assembly

(75) Inventor: Duan-Cheng Hsieh, Taipei City (TW)

(73) Assignee: HABITEX CORPORATION, Taipei City (TW)

(21) Appl. No.: 12/857,969

(22) Filed: Aug. 17, 2010

(51) Int. Cl. F21V 11/00

(52) U.S. Cl. 362/351

(57) ABSTRACT

A lamp seat assembly includes a lampshade and a hollow lamp seat. The lampshade includes a side wall that extends along an axial direction, that has top and bottom ends opposite to each other along the axial direction, and that defines a through hole. The lamp seat includes a surrounding wall that extends along the axial direction and that has a bottom portion surrounded by the side wall of the lampshade, a first engaging member that projects from the bottom portion of the surrounding wall near a bottom end of the bottom portion, and that is disposed below and contacts the bottom end of the side wall, and a second engaging member that projects from the bottom portion of the surrounding wall and that is disposed above and contacts a top end of the side wall, such that the bottom portion of the surrounding wall is retained removably in the through hole of the lampshade.

### BACKGROUND OF THE INVENTION

1. Field of the Invention

The invention relates to a lamp seat assembly, more particularly to a lamp seat assembly that may be assembled and disassembled in a snap-engaging manner.

2. Description of the Related Art

As shown in FIG. 1, the Taiwanese Patent Number M351311 has disclosed a lamp device 1 with a heat-dissipating effect. The lamp device 1 includes a lampshade 11 and an insulation lamp seat 12. The lampshade 11 has a rear end formed with a plurality of threaded holes 111, whereas the lamp seat 12 has a front end formed with a same number of through holes 121, each of which is aligned with a respective one of the threaded holes 111. To mount the lamp seat 12 to the lampshade 11, a screwdriver is used to drive fasteners 13 through the corresponding through holes 121 for fastening threadedly into the corresponding threaded holes 111. Moreover, to remove the lamp seat 12 from the lampshade 11, a screwdriver is also needed to unscrew the fasteners 13 so that the fasteners 13 may be removed from the corresponding through holes 121 and the corresponding threaded holes 111.

However, this sort of fastening manner that uses the fasteners 13 requires a screw driver for assembly and disassembly of the lamp seat 12, which is inconvenient in operation and time-consuming. Moreover, the fasteners 13 increase the incurred cost. As such, it is desirable to design a structure of a lamp seat assembly that dispenses with fasteners and that facilitates assembly and disassembly operations.

### SUMMARY OF THE INVENTION

Therefore, the object of the present invention is to provide a lamp seat assembly that can overcome the aforesaid drawbacks of the conventional lamp seat assembly.

Accordingly, a lamp seat assembly of this invention comprises a lampshade and a hollow lamp seat.

The lampshade includes a side wall that extends along an axial direction, that has top and bottom ends opposite to each other along the axial direction, and that defines a through hole. The lamp seat includes a surrounding wall that extends along the axial direction and that has a bottom portion surrounded by the side wall of the lampshade, at least one first engaging member that projects from the bottom portion of the surrounding wall at a position adjacent to a bottom end of the bottom portion, and that is disposed below and contacts the bottom end of the side wall of the lampshade, and a second engaging member that projects from the bottom portion of the surrounding wall and that is disposed above and contacts a top end of the side wall of the lampshade, such that the bottom portion of the surrounding wall is retained removably in the through hole of the lampshade.

Preferably, the bottom portion of the surrounding wall of the lamp seat is formed with at least one slit that extends upwardly from the bottom end of the bottom portion and that extends parallel to the axial direction, thereby enabling the bottom portion of the surrounding wall to move resiliently and inwardly when the first engaging member is inwardly pressed.

Preferably, the first engaging member of the lamp seat has a first engaging surface, and a second engaging surface disposed above the first engaging surface along the axial direction, and contacts slidably the bottom end of the side wall of the lampshade. The bottom portion of the surrounding wall is urged to move resiliently and inwardly when the first engaging surface of the first engaging member contacts slidably the top end of the side wall of the lampshade during retention of the bottom portion of the surrounding wall in the through hole of the lampshade, and when the second engaging surface of the first engaging member contacts slidably the bottom end of the side wall of the lampshade during removal of the bottom portion of the surrounding wall from the through hole of the lampshade.

Preferably, the side wall of the lampshade further has first and second guide surfaces that are formed obliquely and respectively at the top and bottom ends thereof. The bottom portion of the surrounding wall is urged to move resiliently and inwardly when the first engaging member contacts slidably the first guide surface of the side wall of the lampshade during retention of the bottom portion of the surrounding wall in the through hole of the lampshade, and when the first engaging member contacts slidably the second engaging surface of the side wall of the lampshade during removal of the bottom portion of the surrounding wall from the through hole of the lampshade.

Preferably, the lamp seat includes a plurality of angularly spaced-apart ones of the first engaging members that are disposed below and contact the bottom end of the side wall of the lampshade, each of the first engaging members being formed with the first and second engaging surfaces; and the bottom portion of the surrounding wall of the lamp seat is formed with a plurality of the slits that are arranged alternately with the first engaging members.

By using the first engaging member and the second engaging member of the lamp seat to engage the bottom end and the top end of the side wall of the lampshade, the lamp seat assembly eliminates the need for separate fasteners and facilitates assembly and disassembly operations.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional lamp disclosed in Taiwanese Patent Number M351311;

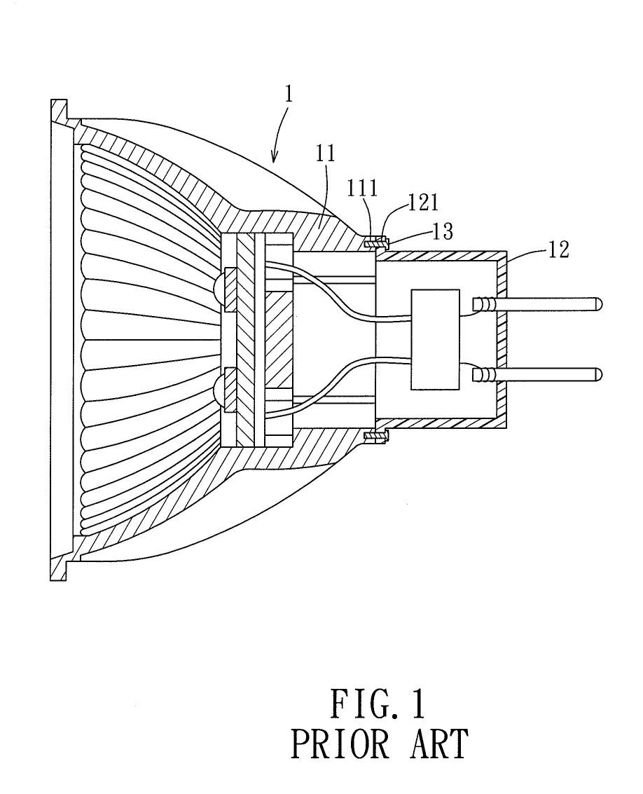

FIG. 2 is an exploded perspective view of the preferred embodiment of a lamp seat assembly according to the present invention;

FIG. 3 is an exploded partly sectional view of the preferred embodiment;

FIG. 4 illustrates assembly operation of a lamp seat of the preferred embodiment to a lampshade by abutting a first engaging surface of a first engaging member against a first guide surface of a side wall;

FIG. 5 is an assembled partly sectional view of the preferred embodiment for illustrating the first engaging member and a second engaging member engaging respectively bottom and top ends of the side wall; and

FIG. 6 illustrates disassembly operation of the lamp seat of the preferred embodiment relative to the lampshade by abutting a second engaging surface of the first engaging member against a second guide surface of the side wall.

### DETAILED DESCRIPTION OF THE PREFERRED EMBODIMENT

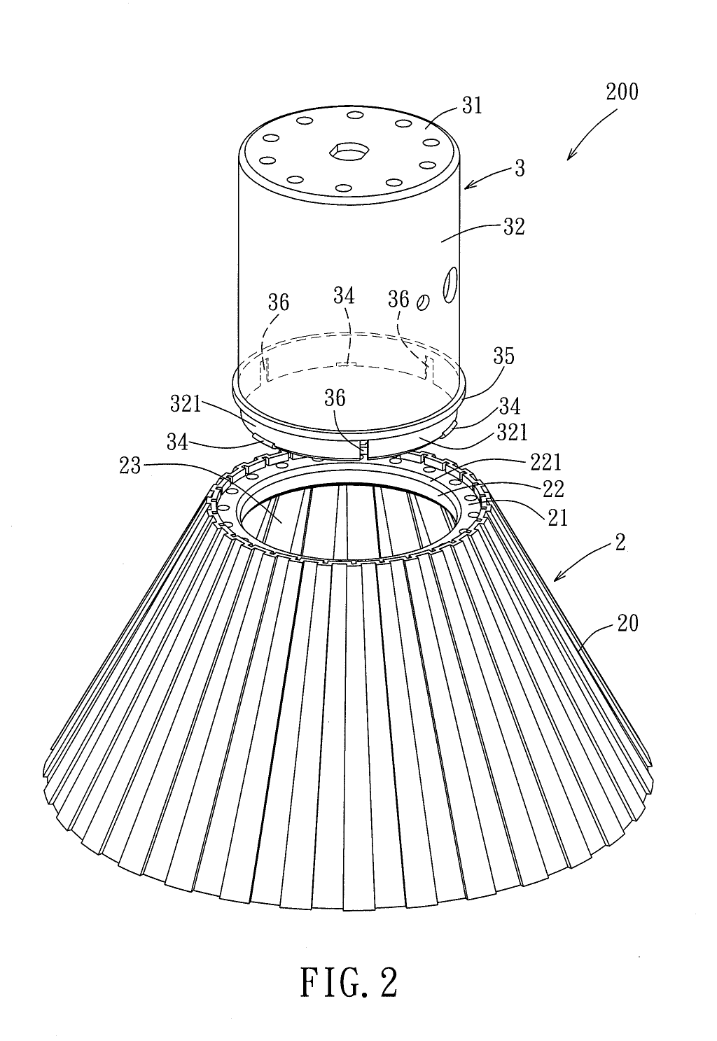

Referring to FIG. 2, the preferred embodiment of a lamp seat assembly 200 according to the present invention is shown to comprise a lampshade 2 and a lamp seat 3 mounted removably on the lampshade 2.

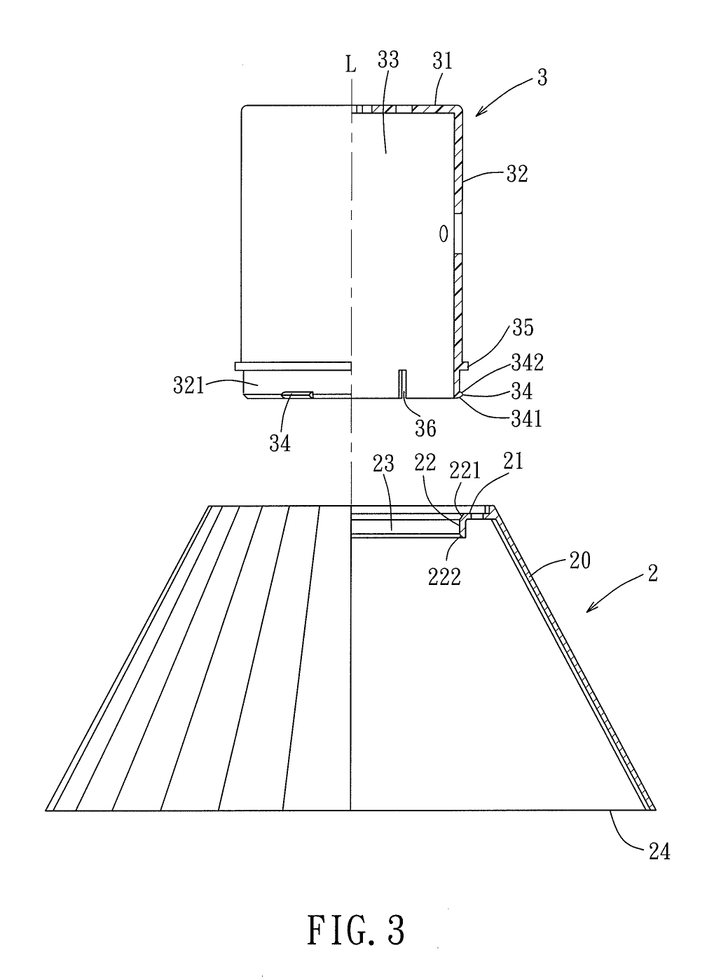

With further reference to FIG. 3, the lampshade 2 is made of metal material with a good heat dissipation effect, and includes a shade body 20, an annular wall 21 extending inwardly from a top end of the shade body 20, and a side wall 22 that extends downwardly from an inner periphery of the annular wall 21 along an axial direction (L), that has top and bottom ends opposite to each other along the axial direction (L), and that defines a through hole 23. The lamp seat assembly 200 further includes an LED lighting unit (not shown in the Figures) that is to be fastened to a bottom side of the annular wall 21 and that emits light for passage through an opening 24 formed at a bottom end of the shade body 20.

The lamp seat 3 is made of insulating material, and is mounted removably in the through hole 23 of the lampshade 2. The lamp seat 3 includes a base wall 31 and a surrounding wall 32 extending downwardly from an outer peripheral edge of the base wall 31. The base wall 31 and the surrounding wall 32 cooperate to define an accommodation space 33 having a bottom opening. The accommodation space 33 is adapted to accommodate a driving circuit board (not shown in the Figures). The driving circuit board is coupled electrically to the

LED lighting unit so as to provide power for the LED lighting unit. The lamp seat 3 further includes a plurality of first engaging members 34 that are angularly spaced apart from each other and that project from the bottom portion of the surrounding wall 32 at a position adjacent to a bottom end of the bottom portion of the surrounding wall 32, and a second engaging member 35 that projects from the bottom portion of the surrounding wall 32 and that is disposed above the first engaging members 34. Each of the first engaging members 34 has a rib shape and is disposed below and contacts the bottom end of the side wall 22 of the lampshade 2. The second engaging member 35 has a ring shape and is disposed above and contacts the top end of the side wall 22 of the lampshade 2, such that the lamp seat 3 is capable of engaging and being positioned relative to the side wall 22 of the lampshade 2.

Preferably, the bottom portion of the surrounding wall 32 of the lamp seat 3 is formed with a plurality of slits 36, each of which extends upwardly from the bottom end of the bottom portion, extends parallel to the axial direction (L), and is disposed between an adjacent pair of the first engaging members 34 (i.e., the slits 36 are arranges alternately with the first engaging members 34). Each adjacent pair of the slits 36 configures the surrounding wall 32 with a resilient wall portion 321. The resilient wall portions 321 of the surrounding wall 32 are able to move resiliently and inwardly when the first engaging members 34 are pressed inwardly, such that the lamp seat 3 may be quickly assembled to or disassembled from the lampshade 2.

Preferably, each of the first engaging members 34 of the lamp seat 3 has a first engaging surface 341 facing down and a second engaging surface 342 facing up, whereas the side wall 22 has a first guide surface 221 formed obliquely at the top end thereof, and a second guide surface 222 formed obliquely at the bottom end thereof. Through abutment between the first engaging surfaces 341 and the first guide surface 221 or abutment between the second engaging surfaces 342 and the second guide surface 222, the first guide surface 221 and the second guide surface 222 serve to press inwardly and contract resilient wall portions 321, so that during assembly or disassembly of the lamp seat 3, friction between the first engaging members 34 and the side wall 22 is reduced, and the lamp seat 3 may be smoothly mounted and positioned relative to the side wall 22 of the lampshade 2, or removed from the side wall 22. It is worthwhile to mention that, in design, implementation with only the first engaging surfaces 341 and the second engaging surfaces 342 and without the first guide surface 221 and the second guide surface 222, or with only the first guide surface 221 and the second guide surface 222 and without the first engaging surfaces 341 and the second engaging surfaces 342, likewise achieves the effect of reducing friction between the first engaging members 34 and the side wall 22. Furthermore, there may only be one first engaging member 34 and one slit 36 in other embodiments of this invention.

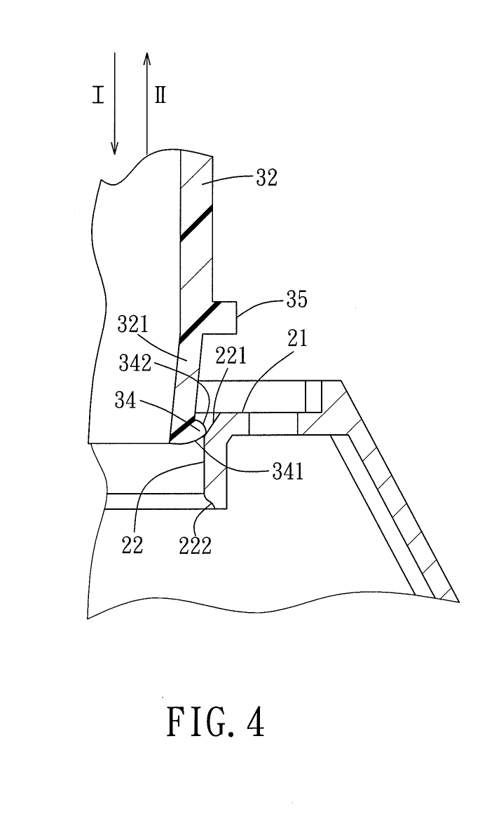

As shown in FIGS. 3, 4 and 5, to mount the lamp seat 3 to the lampshade 2, either the lamp seat 3 is pressed downward toward the lampshade 2 along a direction (I), or the lampshade 2 is pressed upward toward the lamp seat 3 along a direction opposite to that of the arrow symbol (I), so that the first engaging surfaces 341 of the first engaging members 34 are to contact slidably the first guide surface 221 of the side wall 22, and the first guide surface 221 of the side wall 22 exerts a lateral force component on the first engaging members 34 so as to urge that the resilient wall portions 321 of the surrounding wall 32 to move inwardly and resiliently, such that the first engaging members 34 can move downward smoothly along the inner wall side of the side wall 22, and as a result, extend through the through hole 23. When the second engaging member 35 engages the top end of the side wall 22 of the lampshade 2, the lamp seat 3 is stopped from further downward movement. In the meantime, the first engaging members 34 have moved past the inner wall side of the side wall 22, and, due to the restorative resiliency of the resilient wall portions 321, the first engaging members 34 are restored to the original states thereof, such that the second engaging surfaces 342 of the first engaging members 34 engage the second guide surface 222 of the bottom end of the side wall 22. The lamp seat 3 is mounted and positioned relative to the lampshade 2 at this time.

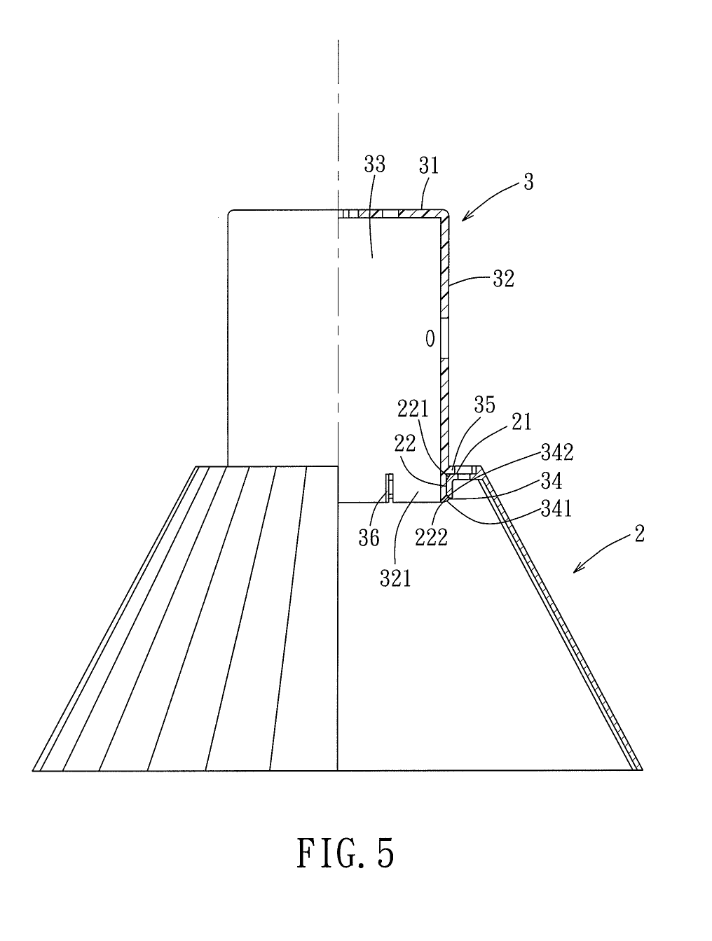

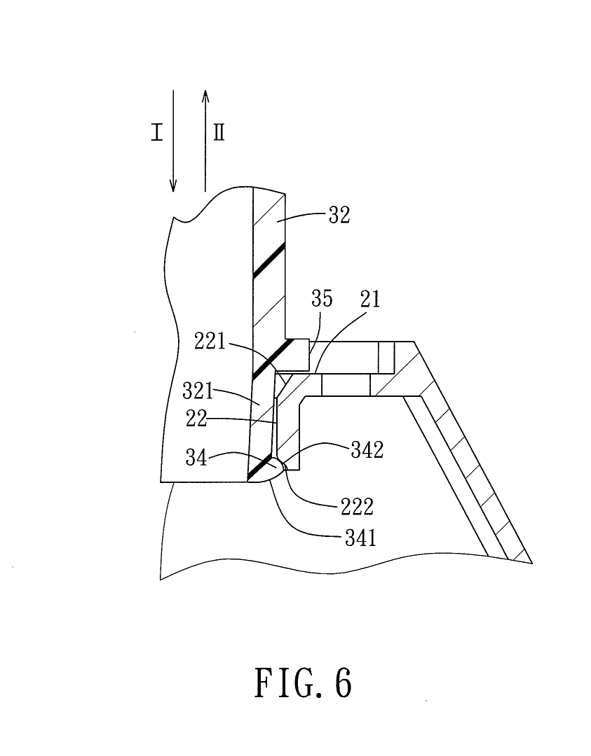

As shown in FIGS. 5 and 6, to dismount the lamp seat 3 from the lampshade 2, the lamp seat 3 is pulled upward from the lampshade 2 along the direction (II), or the lampshade 2 is pulled downward from the lamp seat 3 along the direction (I), so that the second engaging surfaces 342 of the first engaging members 34 are to slide relative to the second guide surface 222 of the side wall 22, and the second guide surface 222 of the side wall 22 exerts a lateral force component on the first engaging members 34, so as to urge the resilient wall portions 321 of the surrounding wall 32 to move inwardly and resiliently, such that the first engaging members 34 can move upward smoothly along the inner wall side of the side wall 22, and as a result, be removed from the through hole 23. When the first engaging members 34 are detached from the inner wall side of the side wall 22, the lamp seat 3 is removed from the lampshade 2.

In summary, in the lamp seat assembly 200 of this invention, by using the first engaging member 34 and the second engaging member 35 of the lamp seat 3 to engage the bottom end and the top end of the side wall 22 of the lampshade 2, and also by the design of the slits 36, the lamp seat assembly 200 eliminates the need for separate fasteners and facilitates assembly and disassembly operations.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A lamp seat assembly comprising:
a lampshade including a side wall that extends along an axial direction, that has top and bottom ends opposite to each other along the axial direction, and that defines a through hole; and
a hollow lamp seat including
a surrounding wall that extends along the axial direction and that has a bottom portion surrounded by said side wall of said lampshade,
at least one first engaging member that projects from said bottom portion of said surrounding wall at a position adjacent to a bottom end of said bottom portion, and that is disposed below and contacts said bottom end of said side wall of said lampshade, and
a second engaging member that projects from said bottom portion of said surrounding wall and that is disposed above and contacts a top end of said side wall of said lampshade, such that said bottom portion of said surrounding wall in retained removably in said through hole of said lampshade.

2. The lamp seat assembly as claimed in claim 1, wherein said bottom portion of said surrounding wall of said lamp seat is formed with at least one slit that extends upwardly from said bottom end of said bottom portion and that extends parallel to the axial direction, thereby enabling said bottom portion of said surrounding wall to move resiliently and inwardly when said first engaging member is inwardly pressed.

3. The lamp seat assembly as claimed in claim 2, wherein said first engaging member of said lamp seat has a first engaging surface, and a second engaging surface disposed above said first engaging surface along the axial direction and contacts slidably said bottom end of said side wall of said lampshade, said bottom portion of said surrounding wall being urged to move resiliently and inwardly when said first engaging surface of said first engaging member contacts slidably said top end of said side wall of said lampshade during retention of said bottom portion of said surrounding wall in said through hole of said lampshade, and when said second engaging surface of said first engaging member contacts slidably said bottom end of said side wall of said lampshade during removal of said bottom portion of said surrounding wall from said through hole of said lampshade.

4. The lamp seat assembly as claimed in claim 3, wherein said side wall of said lampshade further has first and second guide surfaces that are formed obliquely and respectively at said top and bottom ends thereof, said bottom portion of said surrounding wall being urged to move resiliently and inwardly when said first engaging member contacts slidably said first guide surface of said side wall of said lampshade during retention of said bottom portion of said surrounding wall in said through hole of said lampshade, and when said first engaging member contacts slidably said second engaging surface of said side wall of said lampshade during removal of said bottom portion of said surrounding wall from said through hole of said lampshade.

5. The lamp seat assembly as claimed in claim 4, wherein:
said lamp seat includes a plurality of angularly spaced-apart ones of said first engaging members that are disposed below and contact said bottom end of said side wall of said lampshade, each of said first engaging members being formed with said first and second engaging surfaces; and
said bottom portion of said surrounding wall of said lamp seat is formed with a plurality of said slits that are arranged alternately with said first engaging members.

6. The lamp seat assembly as claimed in claim 1, wherein said side wall of said lampshade further has first and second guide surfaces that are formed obliquely and respectively at said top and bottom ends thereof, said bottom portion of said surrounding wall being urged to move resiliently and inwardly when said first engaging member contacts slidably said first guide surface of said side wall of said lampshade during retention of said bottom portion of said surrounding wall in said through hole of said lampshade, and when said first engaging member contacts slidably said second engaging surface of said sidewall of said lampshade during removal of said bottom portion of said surrounding wall from said through hole of said lampshade.
